(19) United States
(12) Patent Application Publication
(10) Pub. No.: US 2018/0326696 A1
(43) Pub. Date: Nov. 15, 2018

(54) INTERLAYER FILM WITH SHADE BAND

(71) Applicant: KURARAY EUROPE GMBH, Hattersheim (DE)

(72) Inventors: Shinichi MUGURUMA, Troisdorf (DE); Hirotaka YASUDA, Troisdorf (DE)

(73) Assignee: KURARAY EUROPE GMBH, Hattersheim (DE)

(21) Appl. No.: 15/960,646

(22) Filed: Apr. 24, 2018

(30) Foreign Application Priority Data
May 10, 2017 (EP) 17170328.3

(51) Int. Cl. B32B 3/30; B32B 27/08; B32B 27/30; B32B 27/22; B29C 47/00; B29C 47/06

(52) U.S. Cl. CPC B32B 3/30; B32B 27/08; B32B 27/30; B32B 27/22; B29C 47/0061; B29C 47/0004; B29K 2029/14; B29C 47/065; B32B 2250/04; B32B 2250/24; B32B 2307/412; B32B 2329/06; B29C 47/0021

(57) ABSTRACT

An interlayer film with a transparent and a non-transparent region is constructed by providing a non-transparent region of two outer layers of a first mixture of a plasticizer and a polyvinylacetal, and one inner layer of a second mixture of a plasticizer and a polyvinylacetal, and a transparent region of one layer of a third mixture of a plasticizer and a polyvinylacetal, wherein the first and the third mixtures have a transmission for light of 380 to 780 nm of at least 85%, and the second mixture has a transmission for light of 380 to 780 nm of less than 80%, and wherein at least the non-transparent region is provided with a surface roughness with a ratio of Rz/Rv of 1.6 to 2.5 as measured according to EN ISO 4287.

### CROSS-REFERENCE TO RELATED APPLICATIONS

This application claims priority to European Patent Application No. 17170328.3 filed May 10, 2017, the disclosure of which is incorporated in its entirety by reference herein.

### BACKGROUND OF THE INVENTION

### 1. Field of the Invention

The invention relates to an interlayer film based on plasticized polyvinyl acetal having at least three layers, wherein the inner layer has reduced transparency.

### 2. Background Art

Laminated safety glass usually consists of two glass panes and one adhesive film which combines the glass panes and is based on plasticized polyvinyl acetal, preferably polyvinyl butyral (PVB). Laminated safety glass is used in particular as windscreens in motor vehicles.

Windscreens are often provided with a so-called shade band in the upper part of the windscreen which protects the driver from direct sun light. The shade band of the windscreen is provided by a coloured or tinted region of the interlayer film. This, in turn is provided to the interlayer by extrusion of a small layer of coloured or tinted material between two layers of clear material. As shown in FIG. 1 the coloured or tinted region A has usually a width of about 5 to 30 cm, as seen from the edge of the film, with a decreasing intensity of the colour towards the lower part of the windscreen.

The production of interlayer films based on plasticised polyvinyl acetal having a coloured or tinted region i.e. a shade band is known, with a vast amount of different techniques and extrusion devices. In general, the coloured or tinted region is produced by incorporating a more or less wedge-shaped middle layer between two clear layers, resulting in a decrease of colour (or in increase of transparency) in the direction of the lower part of the windscreen. FIGS. 2 and 3 show schematically a coloured middle layer between two clear layers with a decrease of colour.

Interlayer films for automotive application are usually produced by embossing in order to provide a regular (non-stochastic) surface structure which exhibits good ventilation behaviour particularly in the production process for glass laminates by the vacuum bag process. Embossing of interlayer films is described in WO 2016030284A1, for example.

However, shade band films as depicted in FIGS. 2 and 3 exhibit, at the coloured or tinted region, two inner interfaces at the layers. Such films are for example disclosed in EP 3070063 A1. Since the clear and coloured material have a different composition, they have different mechanical properties. Such different mechanical properties may result in optical distortion at the inner interfaces during embossing, even if the rest of the film, comprising only clear material (i.e. one layer), is free of optical distortion.

### SUMMARY OF THE INVENTION

It was therefore an object of the invention to provide an interlayer film with a shade band by embossing without optical distortion at the inner interfaces of the shade band area. It has now been found that optical distortion created by embossing the shade band area can be avoided when the surface structure created by embossing has the inventive properties, for example a ratio Rz/Rv of 1.6-2.5.

### BRIEF DESCRIPTION OF THE DRAWINGS

FIG. 1 illustrates a prior art windshield with a shade band;

FIG. 2 illustrates a shade band film; and

FIG. 3 illustrates another shade band film

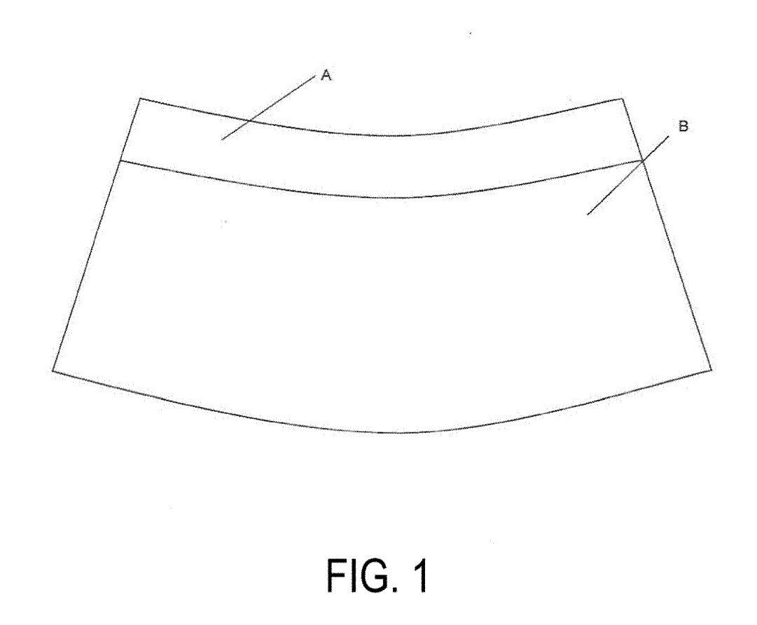

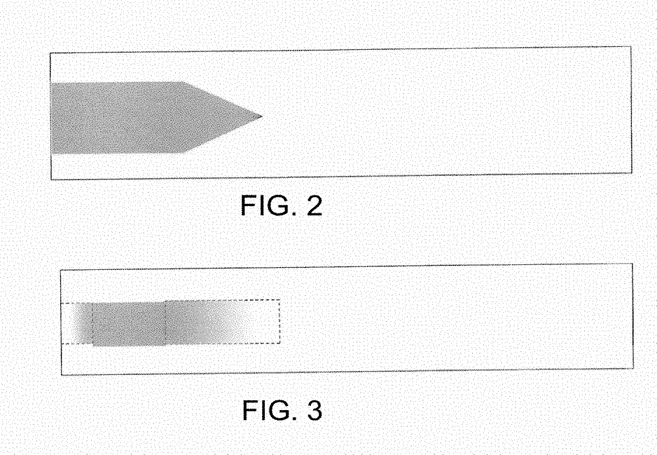

### DETAILED DESCRIPTION OF THE PREFERRED EMBODIMENTS

The object of the present invention is to provide an interlayer film with a transparent and a non-transparent region, wherein the non-transparent region is provided by two outer layers comprising a first mixture of at least one plasticizer and at least one polyvinylacetal and one inner layer comprising a second mixture of at least one plasticizer and at least one polyvinylacetal and the transparent region is provided by one layer comprising a third mixture of at least one plasticizer and at least one polyvinylacetal wherein the first and the third mixture have a transmission for light having a wavelength of 380 to 780 nm of at least 85% and the second mixture has a transmission for light having a wavelength of 380 to 780 nm of less than 80%, and wherein at least the non-transparent region is provided with a surface roughness with a ratio of Rz/Rv of 1.6 to 2.5 as measured according to EN ISO 4287.

Preferably, at least the non-transparent region is provided with a surface roughness having a ratio of Rz/Rv of 1.6 to 2.3, or 1.7 to 2.3; more preferred is a ratio Rz/Rv of 1.9 to 2.1. If the ratio Rz/Rv is greater than 2.5, bad de-airing and bad optical distortions occur. On the other hand, if the ratio Rz/Rv is smaller than 1.6, channels are too deep and bad edge sealing will be the result

The surface roughness of the film may further be embossed with a plurality of channels having a depth Rz of 20 to 100 μm.

Rz and Rv used in the present application are as defined in EN ISO 4287. Rz stands for the mean roughness depth of the surface structures and Rv stands for the depth of the deepest profile valley of the roughness surface within the sampling length. Measuring the surface roughness of the film with the roughness value R_{z} and a maximum profile valley depth of Rᵥ is conducted according to DIN EN ISO 4287. The measuring devices used to measure the surface roughness must satisfy EN ISO 3274. The profile filters used must correspond to DIN EN ISO 11562.

The surface roughness of the non-transparent region of the film can be identical to the surface roughness of the transparent region of the film and may be provided by first extruding the film under melt-fracture conditions, followed by an embossing step.

Accordingly, another object of the invention is a process for manufacturing an interlayer film with a transparent and a non-transparent region, wherein the non-transparent region is provided by two outer layers comprising a first mixture of at least one plasticizer and at least one polyvinylacetal and one inner layer comprising a second mixture of at least one plasticizer and at least one polyvinylacetal and the transparent region is provided by one layer comprising a third mixture of at least one plasticizer and at least one polyvinylacetal wherein the first and the third mixture have a transmission for light having a wavelength of 380 to 780 nm of at least 85% and the second mixture has a transmission for light having a wavelength of 380 to 780 nm of less than 80%, wherein at least the non-transparent region is provided with a surface roughness with a ratio of Rz/Rv of 1.6 to 2.5 by extrusion of the film under melt-fracture conditions followed by an embossing step.

In preferred embodiments of the invention, the transmission of the inner layer for light having a wavelength of 380 to 780 nm is 3-75%, more preferably 8-70% and especially 15-60%.

The inner layer embedded between the outer layers may have an area of 5-40%, preferably 5-25% of the total area of the interlayer film.

Usually, float glass and/or laminated glazing for automobile use has a transmission for light having a wavelength of 380 to 780 nm of at least 88%.

For coloring, coloring agents, pigments and dyes can be used without particular limitation.

Examples of pigments include organic pigments such as azo pigments, phthalocyanine pigments, quinacridone pigments, perylene pigments, dioxazine pigments, anthraquinone pigments, isoindolino pigments etc., oxides, hydroxides, sulfides, chromic acid, carbonates, silicates, Inorganic pigments such as arsenate, ferrocyanide, carbon, metal powder and the like.

Examples of dyes include dyes such as azo, anthraquinone, phthalocyanine, quinacridone, perylene, dioxazine, indolinone, isoindolino, quinoneimine, triphenylmethane, thiazole, nitro and nitroso Dyes. Among them, azo and anthraquinone dyes are preferably used as dyes which hardly block light rays having a wavelength of near infrared light (750 to 1000 nm).

Shade band PVB film i.e. a film comprising plasticized polyvinylacetal having a non-transparent region and a transparent region can for example be extruded according to the method disclosed in WO 2005090054 A1. The outer layers of the non-transparent region combine outside the shade band (i.e. in the transparent region) into a single layer. Preferably, the outer layers have identical compositions. The inner layer may have the same basic composition, other than the colour, as the outer layers.

The stochastic surface pattern on the elevations between the channels are created during the extrusion of the film and should remain during embossing essentially as obtained during extrusion.

Preferably, the surface roughness of the elevations between the channels obtained after embossing is at most 20%, more preferably at most 10% lower than as obtained after extrusion. At best, the surface roughness of the elevations between the channels obtained after extrusion and embossing is identical. This can be achieved by an embossing tool which does not or does not fully have contact with the film in the areas of the elevations.

The extrusion of the melt comprising plasticised polyvinyl acetal is preferably performed under melt fracture conditions with an extrusion die having lips whose temperature can be adjusted. Such an extrusion process is known to one skilled in the art, for example from EP 0 185 863 B1.

The stochastic surface pattern on the elevations between the channels may be the same or different on the different surfaces of the film. Different surface patterns or roughness levels can be produced by varying the width of the discharge gap and the temperature of the die lips directly on the die exit during melt fracture extrusion.

It is preferred to perform the extrusion process to obtain a film with a stochastic roughness of the surfaces of Rz=10 to 70 μm and more preferably to obtain a film with a stochastic roughness of the surfaces of Rz=25 to 60 μm.

In a first variant of the invention, the extrusion is performed under melt-fracture conditions with extrusion dies having a lip temperature of 100-270° C., preferably 100-240° C.

In a second variant of the invention, the extrusion under melt-fracture conditions is performed with a melt flow rate of 500-3500 kg/h.

Subsequent to extrusion, the film is subjected to embossing in step b) on one or both sides, independently in each case with a surface structure and a roughness depth of R_{z}=20 to 100 μm, preferably R_{z}=20 to 80 μm, in particular R_{z}=25 μm to 70 μm.

The final surface structure of the film can be embossed in a single step or preferably in two distinct embossing steps. In single step embossing, two embossing rolls are used, whereas in multiple step embossing, an embossing roller and a pressure roller is used. The pressure roller preferably has a surface of rubber with a Shore A hardness of 20-80.

The embossing step according to the invention can be carried out in such a way that the two sides of the structured film have different roughness depths R_{z}. This can be achieved e.g. by different embossing tools or temperatures of the embossing tools and/or the pressing rollers.

The channels on both surfaces of the film may share an angle of 70 to 90° or 5-45° with each other. In another embodiment, the channels on at least one surface of the film have an angle of 5-45°, preferably 35-45° to the direction of extrusion.

The pitch of the channels can be the same or different on the surfaces of the film, where a deviation of 5% between the surfaces is being as the same. The pitch of the channels can be 100-1500 μm, preferably 200-1000 μm.

Before and/or after the embossing process, the film can be cooled to −10 to +40° C. to fix the surface structure of the film in this way. Cooling preferably takes place via correspondingly temperature-adjusted cooling rollers.

Preferably, the embossing rollers are made of metal or ceramics and possess a surface with a negative profile pattern of the structure present later on in the film surface. Higher depth of channel than the intended roughness of the film of the embossing rollers is preferable to keep the melt fracture surface after embossing.

The temperature of the embossing rollers is 80 to 200° C., preferably 80 to 170° C., more preferably 100 to 160° C., and in particular 110 to 155° C. Most preferably, the embossing rollers have a coated steel surface (e.g. coated with polymer or ceramics) in order to reduce the adhesion of the film.

In a first embodiment, the extruded film is embossed between two embossing rollers having the same or different surface embossment.

In another embodiment of the invention, the film is guided between the embossing roller and the pressing roller rotating in the opposite sense. Preferably, the film is exposed, between the embossing rollers and/or embossing and pressing rollers to a line pressure of 10 to 400 N/mm, preferably 10 to 150 N/mm, more preferably 30 to 130 N/mm, and in particular 40 to 110 N/mm. The line pressure can be the same or different if several process steps b) are conducted. Line pressure means the pressing force of the roller pair based on the film width.

The pressing rollers preferably have a temperature of 0 to 50° C., more preferably 5 to 30° C., i.e. they are actively cooled vis-à-vis the embossing roller. The temperature of the pressing rollers may be the same or different in process steps b).

The pressing rollers press the film into the structured surface of the embossing rollers and nestle lightly against the embossing roller. By changing the line pressure, the surface of the embossing zone and consequently the residence time of the film in the roller gap can be altered.

By selecting the process parameters of line pressure, film temperature and/or roller temperature, roller speed and enveloping angle of the film web on the rollers, the roughness depth of the film embossing can be influenced with a given roughness depth of the embossing rollers.

In this case, too, the film can be guided through the roller gap of the temperature-adjustment rollers directly, i.e. without passing around them.

It is possible to use in particular polyvinyl butyral (PVB), in the crosslinked or non-crosslinked form as a partially acetalated polyvinyl alcohol, in admixture with at least one plasticiser, metal salts for adhesion regulation, organic additives and/or inorganic fillers.

All plasticisers known in the art for this purpose, in particular the esters of multivalent acids, polyhydric alcohols or oligoether glycols, such as e.g. adipic acid esters, sebacic acid esters or phthalic acid esters, in particular di-n-hexyl adipate, dibutyl sebacate, dioctyl phthalate, esters of diglycol, triglycol or tetraglycol with linear or branched aliphatic carboxylic acids and mixtures of these esters are suitable, on the one hand, as plasticisers for the partially acetalated polyvinyl alcohols. Esters of aliphatic diols with long chain aliphatic carboxylic acids, in particular esters of triethylene glycol with aliphatic carboxylic acids containing 6 to 10 C atoms, such as 2-ethyl butyric acid or n-heptanoic acid are preferably used as standard plasticisers for partially acetalated polyvinyl alcohols, in particular polyvinyl butyral. One or several plasticisers from the group consisting of di-n-hexyl adipate (DHA), dibutyl sebacate (DBS), dioctyl phthalate (DOP), esters of diglycol, triglycol or tetraglycol with linear or branched aliphatic carboxylic acids, in particular triethylene glycol-bis-2-ethyl butyrate (3GH), triethylene glycol-bis-n-heptanoate (3G7), triethylene glycol-bis-2-ethyl hexanoate (3G8), tetraethylene glycol-bis-n-heptanoate (4G7) are most preferably used.

In a particular embodiment of the present invention, the adhesion of the film to the embossing tools can be further reduced by adding a substance reducing adhesion to the film material.

The plasticised partially acetalated polyvinyl alcohol resin preferably contains 25 to 45 parts by weight and more preferably 30 to 40 parts by weight of plasticiser, based on 100 parts by weight of resin.

The partially acetalated polyvinyl alcohols are produced in the known way by acetalation of hydrolysed polyvinyl esters. Formaldehyde, acetaldehyde, propionaldehyde, butyraldehyde and other aldehydes, preferably butyraldehyde, for example, are used as aldehydes.

The preferred polyvinyl butyral resin contains 10 to 25% by weight, preferably 17 to 23% by weight and more preferably 19 to 21% by weight of vinyl alcohol moieties and/or 0 to 20% by weight, preferably 0.5 to 2.5% by weight of acetate moieties.

In a further process variation, a PVB partially crosslinked with a polyaldehyde (in particular glutaraldehyde) and an oxocarboxylic acid (in particular glyoxylic acid) is used as a polymer according to WO 2004/063231 A1. Such a partially crosslinked PVB has a viscosity which is 10 to 50% higher than that of the analogous non-crosslinked PVB.

The water content of the films is preferably adjusted to 0.15 to 0.8% by weight, in particular to 0.3 to 0.5% by weight.

The films produced according to the invention can be used in particular for the manufacture of laminates from one or several glass panes and/or one or several polymer panes and at least one structured film.

During the manufacture of these laminates, a pre-composite is first produced from the glass/polymer panes and the film by pressing, vacuum bag or vacuum ring. As a rule, pre-composite laminates are slightly turbid as a result of air inclusions. The final manufacture of the laminate takes place in the autoclave e.g. according to WO 03/033583.

### EXAMPLES

### Example According to the Invention

0.76 mm thick PVB film with blue shade band containing a nominal level of 38 parts plasticizer per 100 parts PVB resin is extruded according to the method disclosed in WO 2005090054 A1 with the following conditions.

Lip temperature: 195° C.
Melt flow rate: 1000 kg/h.
Line speed; 15 m/min

This PVB film has a melt fracture surface roughness on each side characterized by value of Rz melt fracture of 33 μm (microns). The shade band layer thickness is 300 μm with a light transmittance measured at the edge of the interlayer at the shade band area of 7%.

The outer layers of the non-transparent region combine outside the shade band (i.e. in the transparent region) into a single layer and have identical compositions. The inner layer has the same composition as the outer layers, other than the color.

This PVB film is embossed between two sets of pressing and embossing rollers with the following properties:

### Facility Parameters:

Hardness of the rubber roller: 70±5 Shore A
Roughness of the embossing roller: approximately 200 μm
Pitch of embossing roller: approximately 500 μm
Angle of the channel: 45°
Surface coating: Polymer
Temperature of rubber roller 10° C.

| Example No. | T of embossing roller (° C.) |
|---|---|
| 1 | 135 |
| 2 | 130 |
| 3 | 145 |
| 4 | 120 |
| 5 | 115 |
| 6 | 60 |
| 7 | 155 |

The pressing and embossing rollers of the two embossing stages had identical properties.

The properties of the film are shown in the following tables, wherein “Rz by melt fraction” stands for the roughness after extrusion under melt fracture conditions. “Rz final” stands for the roughness after embossing. “Rv final” stands for the roughness of valley depth after embossing. All values were measured according to DIN ISO 4287.

Examples 1-5 are according to the invention, whereas Examples 6 and 7 are Comparative Examples.

Upper side (μm)

| | Rz | Rz created by melt | Rv | Rz final/ |
|---|---|---|---|---|
| No. | final | fraction | final | Rv final |
| 1 | 50 | 32 | 28 | 1.8 |
| 2 | 45 | 32 | 23 | 2.0 |
| 3 | 59 | 31 | 37 | 1.6 |
| 4 | 40 | 33 | 18 | 2.2 |
| 5 | 36 | 33 | 14 | 2.6 |
| 6 | 33 | 33 | 12 | 2.8 |
| 7 | 69 | 29 | 47 | 1.5 |

Lower side (μm)

| | Rz | Rz created by melt | Rv | Rz final/ |
|---|---|---|---|---|
| No. | final | fraction | final | Rv final |
| 1 | 51 | 32 | 29 | 1.8 |
| 2 | 45 | 33 | 22 | 2.0 |
| 3 | 58 | 31 | 37 | 1.6 |
| 4 | 41 | 33 | 18 | 2.3 |
| 5 | 36 | 33 | 14 | 2.6 |
| 6 | 33 | 33 | 12 | 2.7 |
| 7 | 70 | 30 | 47 | 1.5 |

The optical distortion of the non-transparent region is evaluated by eye inspection. Any optical distortion is seen as a mottled pattern.

Performance after lamination

| | | Optical | |
|---|---|---|---|
| No. | De-airing | distortion | Edge sealing |
| 1 | Good | Good | Good |
| 2 | Good | Good | Good |
| 3 | Good | Good | Good |
| 4 | Good | Good | Good |
| 5 | Fair | Fair | Good |
| 6 | Bad | Bad | Good |
| 7 | Good | Bad | Bad |

Films according to (comparative) example 6 show almost no embossing pattern due to low temperature embossing. Bad de-airing and optical distortion results. Films according to (comparative) example 7 show too much embossing pattern due to high temperature embossing, and bad edge sealing and optical distortion results.

With the process of the invention, plasticized polyvinyl acetal films with a shade band can be produced which have a good optical distortion and better lamination yield.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. Interlayer film with a transparent and a non-transparent region, wherein the non-transparent region is provided by two outer layers comprising a first mixture of at least one plasticizer and at least one polyvinylacetal and one inner layer comprising a second mixture of at least one plasticizer and at least one polyvinylacetal and the transparent region is provided by one layer comprising a third mixture of at least one plasticizer and at least one polyvinylacetal characterized in that the first and the third mixture have a transmission for light having a wavelength of 380 to 780 nm of at least 85% and the second mixture has a transmission for light having a wavelength of 380 to 780 nm of less than 80%, and wherein at least the non-transparent region is provided with a surface roughness with a ratio of Rz/Rv of 1.6 to 2.5 as measured according to EN ISO 4287.

2. The interlayer film of claim 1, wherein the film is provided with a plurality of channels having a depth of 20 to 100 μm on at least one surface.

3. The interlayer film of claim 2, wherein the channels have a depth of 5-50 μm, a width of 10-200 μm, and a pitch of 50-2500 μm.

4. The interlayer film of claim 1, wherein the channels are provided by embossing a film having a stochastic roughness of at least the non-transparent region of Rz=1 to 70 μm between at least one embossing roll and at least one pressure roll.

5. The interlayer film of claim 1, wherein the stochastic roughness of at least the non-transparent region is provided by melt-fracture extrusion the film.

6. The interlayer film of claim 1, wherein the inner layer further comprises a dye or a pigment.

7. The interlayer film of claim 1, wherein the area of the inner layer embedded between the outer layers is 5-40% of the total area of the interlayer film.

8. A process for manufacturing an interlayer film of claim 1, having a transparent and a non-transparent region, comprising providing a non-transparent region comprising two outer layers each comprising a first mixture of at least one plasticizer and at least one polyvinylacetal, and one inner layer comprising a second mixture of at least one plasticizer and at least one polyvinylacetal; providing a transparent region comprising one layer comprising a third mixture of at least one plasticizer and at least one polyvinylacetal, wherein the first and the third mixture have a transmission for light having a wavelength of 380 to 780 nm of at least 85%, and the second mixture has a transmission for light having a wavelength of 380 to 780 nm of less than 80%, and providing at least the non-transparent region with a surface roughness with a ratio of Rz/Rv of 1.6 to 2.5 by extruding the film under melt-fracture conditions followed by embossing.

9. The process of claim 8, wherein a film with a transparent and a non-transparent region with a stochastic roughness of the surfaces of Rz=1 to 70 μm is extruded and then embossed between at least one embossing roll and at least one pressure roll.

10. The process of claim 8, wherein the film is embossed with a plurality of channels having a depth of 20 to 100 μm.

11. The process of claim 9, wherein the film is embossed with a plurality of channels having a depth of 20 to 100 μm.

12. The process of claim 8, wherein the channels have a depth of 5-50 μm, a width of 10-200 μm and a pitch of 50-2500 μm.

13. The process of claim 9, wherein the channels have a depth of 5-50 μm, a width of 10-200 μm and a pitch of 50-2500 μm.

14. The process of claim 10, wherein the channels have a depth of 5-50 μm, a width of 10-200 μm and a pitch of 50-2500 μm.

15. The process of claim 11, wherein the channels have a depth of 5-50 μm, a width of 10-200 μm and a pitch of 50-2500 μm.
